(19) United States
(12) Patent Application Publication
(10) Pub. No.: US 2017/0249309 A1
(43) Pub. Date: Aug. 31, 2017

(54) Interpreting and Resolving Conditional Natural Language Queries

(71) Applicant: Microsoft Technology Licensing, LLC, Redmond, WA (US)

(72) Inventor: Ruhi Sarikaya, Redmond, WA (US)

(73) Assignee: Microsoft Technology Licensing, LLC, Redmond, WA (US)

(21) Appl. No.: 15/056,781

(22) Filed: Feb. 29, 2016

(51) Int. Cl. G06F 17/30; G06N 5/02

(52) U.S. Cl. CPC G06F 17/3043; G06F 17/3051; G06N 5/02

(57) ABSTRACT

Techniques to interpret and resolve natural language queries that contain conditions are presented. The domains, intents, and slots for the condition portion and the action portion may be identified. The identified domain, intents, and slots may be delivered to another device or application for further processing.

Computers are offering more ways for a user to interact with the computer so that the computers will perform one or more actions for the user. For example, users of computing devices can now interact with a computing device, such as a mobile phone, using natural language queries. Typically, users use natural language queries to request a computer to perform an action, and the computer attempts to perform the action contemporaneously with the query. It would, however, be beneficial if a user could interact with a computer using a natural language query and direct a computer to perform an action only after a condition has occurred.

It is with respect to these and other general considerations that aspects of the technology have been made. Also, although relatively specific problems have been discussed, it should be understood that the aspects of the technology presented should not be limited to solving the specific problems identified in the background.

### SUMMARY

The disclosure generally relates to systems and methods for processing natural language queries that contain one or more conditional statements. Various techniques for interpreting conditional natural language queries are presented. Aspects of the technology include identifying the portions of a conditional query that relate to the condition(s) that must be met (e.g., the condition portion) and identifying the portions of the conditional query that relate to the action(s) (e.g., the action portion) a computer application is meant to take once the condition(s) are met. In aspects, various applications and arguments are identified from the conditional natural language query so that the appropriate action may be taken once the condition has been met. The actions, conditions, applications, and arguments for the application may be sent to an application or service for processing.

As a specific example to aid in clarity, the natural language expression “anytime my kid calls when I am in a meeting, allow it to ring through” is a conditional natural language query. The technology described herein presents methods to resolve this conditional natural language query (and others) into its constituent parts. The parts may include the condition portion “anytime my kid calls when I am in a meeting,” and an action portion “allow it to ring through.” Each portion may be analyzed. For example, the condition portion may be analyzed to determine whether, and if so, what conditions are contained in the query. In the example, there are two conditions (also referred to as triggers): (1) if in meeting equals true; and (2) my kid is calling equals true. A semantic frame may be constructed for the query. A semantic frame is a coherent structure of related concepts that have been identified from analysis of the query. Usually, the semantic frame will include the domain application(s), conditions (e.g., triggers) and/or intents, and/or the arguments to provide to the domain application (e.g., slots). Continuing with the previous example, the semantic frame for the condition portion may be as follows: 1) First Condition: Domain=calendar app.; Trigger=in a meeting; Slots=user's calendar and current time; and 2) Second Condition: Domain=phone application; Trigger=receive call from kid; Slots=kid's incoming number. Thus, with this semantic frame, the conditions may be resolved to true when 1) a calendar application has the user scheduled in a meeting during the current time; and 2) the user receives a phone call, during the current time, from a specific contact number that has been identified as belonging to the child of the user. Similarly, the action portion may be analyzed to determine the intent of the action portion (e.g., turn off do not disturb setting.) In this example, the semantic frame is: Domain=phone application; Intent=turn off do not disturb; Slots=do not disturb setting. Thus, when the condition(s) are set to true, an application may turn of the do not disturb setting.

It will be appreciated that this is just one example, and other examples are contemplated. Further, while the example above identified the condition portions and the action portion prior to resolving the semantic meaning, such order is but one possible order for resolving a query. Other orders are described below. Additionally, this Summary is provided to introduce a selection of concepts that are further described below in the Detailed Description section. This Summary is not intended to identify key features or essential features of the claimed subject matter.

### BRIEF DESCRIPTION OF THE DRAWINGS

FIG. 1 illustrates a networked-computing environment for resolving conditional natural language queries.

FIG. 2 illustrates an alternative networked-computing environment for resolving conditional natural language queries.

FIG. 3 illustrates a system for resolving conditional natural language queries.

FIG. 4 illustrates an additional system for resolving conditional natural language queries.

FIG. 5 is an illustration of the resolution of a conditional natural language query.

FIG. 6 is an alternative illustration of the resolution of a conditional natural language query.

FIG. 7 is a method of segmenting a conditional natural language query.

FIG. 8 is a method of classifying conditions.

FIG. 9 is a method of determining one or more intents of a conditional natural language query.

FIG. 10 is a method of determining one or more keywords/entities in a natural language query.

FIG. 11 is a method of determining semantic structure of a natural language query.

FIG. 12 is a method of classifying intents.

FIG. 13 illustrates an exemplary tablet computing device that may execute one or more aspects disclosed herein.

FIGS. 14A and 14B illustrate a mobile computing device, for example, a mobile telephone, a smart phone, a personal data assistant, a tablet personal computer, a laptop computer, and the like, with which examples of the invention may be practiced.

FIG. 15 illustrates one example of the architecture of a system for providing an application that transforms user queries.

### DETAILED DESCRIPTION

Systems and methods are disclosed herein to transform a conditional natural language query into its constituent parts, e.g., at least one action and at least one condition to perform the action. As used herein, a natural language query is an input to a computing device that is not necessarily structured in way readily understandable by the computing device. That is, the meaning of the sentence may be understood by a person, but may not be readily understood by a computer. A conditional natural language query is a natural language query that has a meaning that includes an action that the user wants the computer to take and a condition that the user wants to be met prior to the action being taken.

Generally, technologies disclosed herein refer to resolving a conditional natural language query. Resolution of the conditional natural language query may include identifying the likely intent of a user. The likely intent of the user may be to have the computer perform an action (or cause the action to be performed) when a certain condition (i.e., trigger) is met.

Additionally, resolving natural language queries also includes the identification of a domain application (or domain) that may be used to effectuate the identified intent of the user. For example, if it is identified that a user wants to make a phone call, then a phone-call domain application may be identified. Similarly, if it is identified that a user wishes to make a phone call after they have reached a location, both a phone-call domain and a location application domain may be identified.

Domain applications may need to be supplied arguments, or slots. So, for example, a slot for a phone call domain includes the number to call. The identification of the slot may come from the conditional natural language query. For example, if a conditional natural language query is “call home when I get to school,” the word home may be resolved to a number to be fed into the phone call application domain.

Further, resolution of keywords and entities may be helpful in determining intents, domains, triggers, and slots. A keyword/entity may be any word(s) or phrase(s) in a natural language query which resolution of the word or phrase aids in creating a semantic frame for the natural language query. For example, a keywords and entities are words or phrases that have, as used in the context of the natural language query, an alternative meaning than the literal definition. For example, the words “super bowl” typically would not literally mean an excellent stadium, but normally refers the championship game of the National Football League. As another example “home” typically would not mean a general dwelling when a person says “call home,” but likely means the home phone number associated with the user's making the request. As another example, if “THE” were the name of a restaurant then “THE” would need to be resolved to understand the conditional natural language query “if I am free tonight, “book a table for two at THE,” where “THE” is the name of the restaurant. Keywords could also be the attributes of the entities, e.g. the word “expensive” in the phrase “expensive Chinese restaurant.” In some aspects keyword/entity definitions are stored in a databases, and the definitions are looked up when it is determined that a natural language query includes a keyword/entity

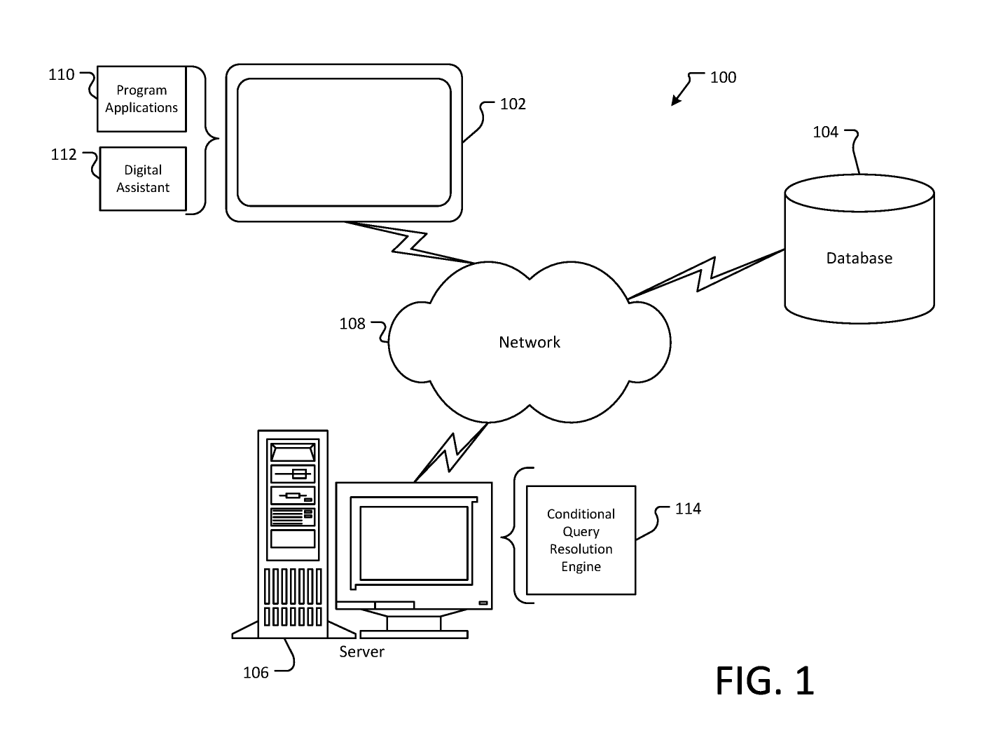

Turning now to FIG. 1, FIG. 1 illustrates a networked-computing environment 100 for resolving conditional natural language queries. As illustrated, FIG. 1 includes a computing device 102, a networked-database 104, and a server 106, each of which is communicatively coupled to each other via a network 108.

The computing device 102 may be any suitable type of computing device. For example, the computing device 102 may be one of a desktop computer, a laptop computer, a tablet, a mobile telephone, a smart phone, a wearable computing device, or the like. Additionally, aspects of the current technology include the computing device storing one or more program applications 110 and storing a digital assistant 112.

Program applications 110 include software running on the computing device 102. The program applications include phone applications, calendar applications, reminder applications, map applications, browsers, and the like. The program applications 110 may be complete applications, or they may be thin user-interfaces that communicate with a remote device, such as a server, to perform processing related to the program applications. Multiple program applications 110 may be stored on the computing device 102. Aspects of the technology include the program applications 110 having the ability to receive conditional natural language queries, such as through text, touch, and/or speech input. For example, program applications 110 may be a settings application, and the user may enter a conditional natural language query into the settings application through speech.

The program applications 110 may be capable of resolving the conditional natural language query. For example, where a program application is a settings application, the received conditional query may be resolved by turning off a setting (such as do not disturb) when a specific user has called.

In aspects of the technology, program applications 110 first send the received conditional natural language query to a conditional query resolution engine 114 prior to resolving the query. For example, the program applications 110 may receive a conditional natural language query and send the received query to a conditional query resolution engine 114 via a network 108. In aspects, the program applications 110 may send the received query to the conditional query resolution engine 114 after the program application 110 determines that the conditional natural language query contains a conditional trigger word(s), such as “if,” “when,” “in the event that,” and the like. Indeed, a library of trigger words may be stored/updated in the database 104 and be accessible by the program application.

Additionally, aspects of the technology include a digital assistant 112 being located on a computing device 102. The digital assistant 112 may receive conditional natural language queries via an interface, such as a microphone, a graphical user interface, via a network, etc. The received query is interpreted, and, in response, the appropriate action is performed. For example, the digital assistant 112 may respond to requests or questions from a user of a computing device 102. Such requests or questions may be conditional natural language queries entered into the computing device 102 in a variety of ways including text, voice, gesture, and/or touch. The digital assistant 112 may interpret the conditional natural language query and resolve the query itself. In aspects, the digital assistant 112 sends the conditional natural language query to another application (located on the computing device 102 and/or another computing device such as the server 106).

Further, the digital assistant 112 may send a conditional natural language query to a conditional query resolution engine 114. For example, the a digital assistant 112 may receive a conditional natural language query and send the conditional natural language query to the conditional query resolution engine 114 via a network 108. In aspects, the digital assistant 112 may send the received query to the conditional query resolution engine 114 after the digital assistant 112 determines that the natural language conditional query contains a conditional trigger word(s), such as “if,” “when,” “in the event that,” and the like. Indeed, a library of trigger words may be stored/updated in the database 104 and be accessible by the program application.

As illustrated, the conditional query resolution engine 114 may reside on a remote device, such as server 106. In other examples, however, the conditional query resolution engine may reside on computing device 102. The conditional query resolution engine 114 receives queries from computing devices such as computing device 102. The conditional query resolution engine 114 receives a conditional query, identifies the portions of the query that relate to the condition(s) and action(s), and creates a semantic frame for each portion. The conditional query resolution engine 114 may accomplish this by parsing the conditional natural language query to identify intents, keywords, and entities. The conditional query resolution engine 114 may assign the intents, keywords, and entities to a condition aspect and/or an action aspect of the conditional natural language conditional query.

System 100 may also include a database 104. The database 104 may be used to store a variety of information including information used to perform one or more techniques associated with resolving conditional natural language queries. For example, a list of conditional trigger words may be stored in database 104.

Network 108 facilitates communication between devices, such as computing device 102, database 104, and server 106. The network 108 may include the Internet and/or any other type of local or wide area networks. Communication between devices allows for the exchange of natural language queries as well as resolution of conditional natural language queries.

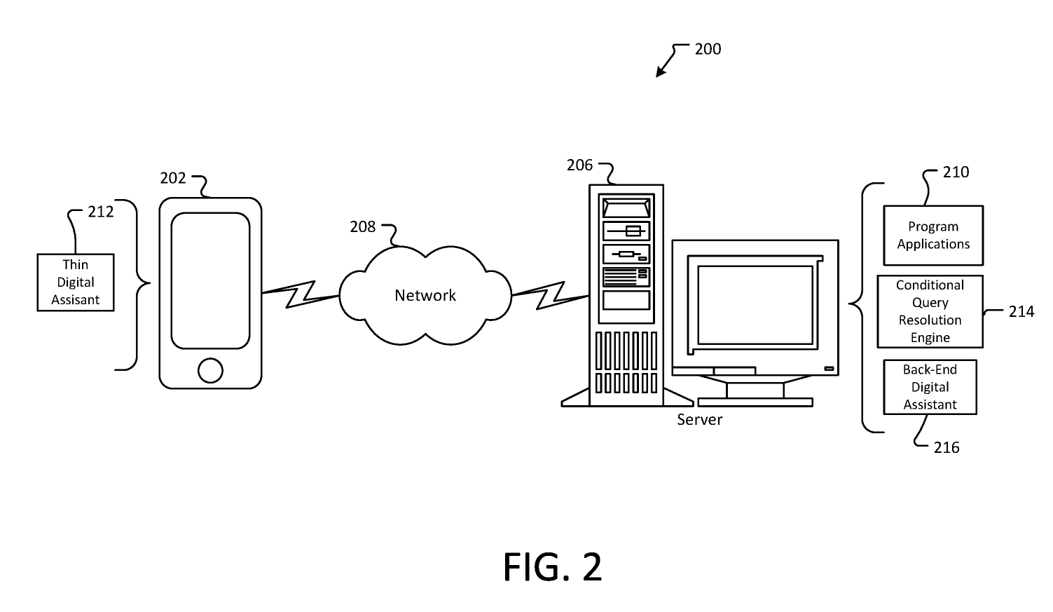

FIG. 2 illustrates an alternative environment 200 for resolving conditional natural language queries. As illustrated, the networked environment 208 includes a computing device 202 and a server 206, each of which is communicatively coupled to each other via a network 208. It will be appreciated that the elements of FIG. 2 having the same or similar names as those of FIG. 1 have the same or similar properties.

As illustrated, a thin-digital assistant 212 is stored on a computing device 202. The thin-digital assistant 212 is configured to display audio and visual messages and receive input (such as conditional natural language queries). The input may be sent via a network 208 to a server 206, and some or all of the processing of received requests is completed by the back end digital assistant 216. Further the back end digital assistant 216 works with the thin-digital assistant 212 to provide the same or similar user experience as the digital assistant described with reference to FIG. 1.

Additionally, the networked system includes a server 206 hosting the program applications 210 and the conditional query resolution engine 214, which may be the same or similar to the conditional query resolution engine 114. The program applications 210 may resolve queries that are received by the computing device 202. While FIG. 1 and FIG. 2 illustrate systems in a particular configuration, it will be appreciated that a conditional query resolution engine, a digital assistant, and program applications may be distributed across a variety of computing devices in a variety of ways to facilitate the resolution of conditional natural language queries.

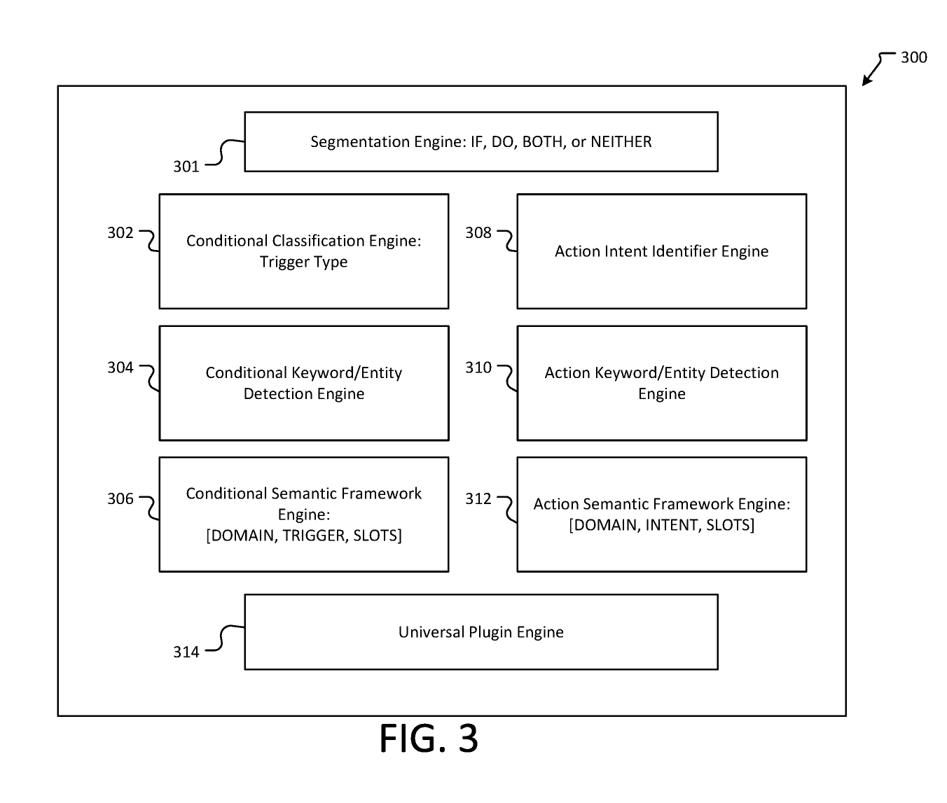

FIG. 3 illustrates a system for resolving conditional natural language queries. The system 300 may make up part or all of the conditional query resolution engine describe with reference to FIGS. 1 and 2. In aspects, system 300 includes a segmentation engine 301, a conditional classification engine 302, a conditional keyword/entity detection engine 304, a conditional semantic frame engine 306, an action intent identifier engine 308, an action keyword/entity detection engine 310, and an action semantic frame engine 312. The components described in FIG. 3 may be implemented in hardware, software, or a combination of hardware and software. It will be appreciated that while an order of the components in FIG. 3 are presented, a natural language query may be processed by any of the components in any order.

In aspects, a segmentation engine 301 interprets a conditional natural-language expression and divides the phrase into at least one condition and at least one action to take when the at least one condition is satisfied. In an embodiment, the segmentation engine divides the expression into its component terms and then classifies each term in the expression into one of the following categories: condition (e.g. “IF”), action (e.g., “DO”), BOTH, or NEITHER. For example, the phrase “when I get home, text my mom that I got home okay” may be received by a segmentation engine. The segmentation engine may divide and classify this expression as follows:

| | | | |
|---|---|---|---|
| IF | DO | BOTH | NEITHER |

| | | | |
|---|---|---|---|
| when | X | | |
| I | X | | |
| get | X | | |
| home | X | | |
| text | | X | |
| my | | X | |
| mom | | X | |
| that | | X | |
| I | | X | |
| got | | X | |
| home | | X | |
| okay, | | | X |
| please | | | X |

The segmentation engine 301 will thus determine that the condition portion of this expression is “when I get home” and the action portion of this expression is “text my mom that I got home okay.” The segmentation engine 301 may not classify some portions of a natural language query, such as in this example, the word “please.” Other examples of classifying natural language conditional queries in this way include:

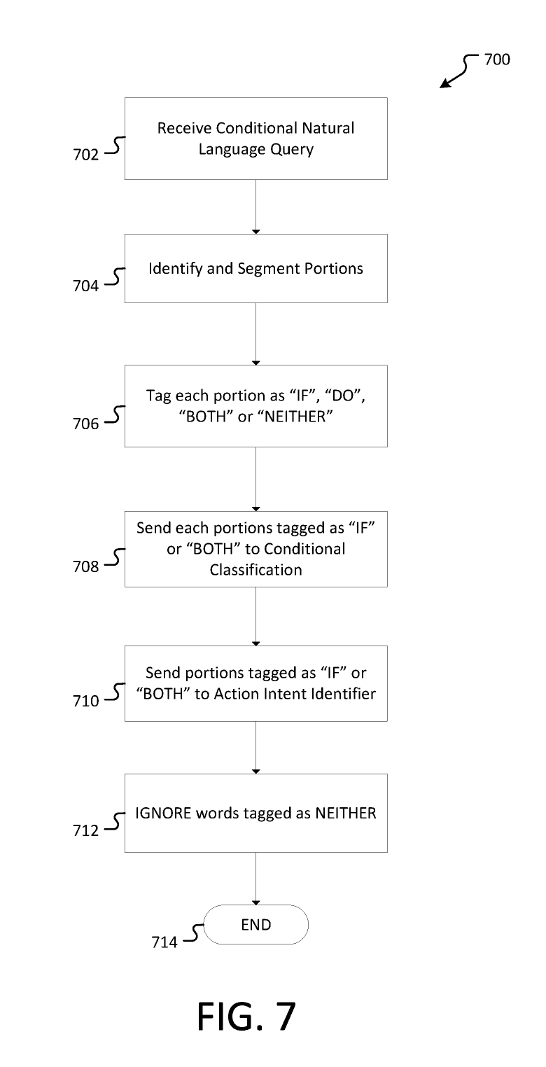

“Pay the electricity bill on the 1st of every month” to:
CONDITION: on the 1^{st} of every month
ACTION: pay the electricity bill
“Text Lauren ‘I'm here’ when I arrive at the SeaTac airport” to:
CONDITION: when
ACTION: text Lauren
BOTH: I arrive at SeaTac airport
“Turn OFF silent mode when my mom calls” to:
CONDITION: when my mom calls
ACTION: turn off silent mode
“Notify me when Mike answers ‘Idea Factor Pitch’ email” to:
CONDITION: when
ACTION: Notify me
BOTH: Mike answers Idea Factor Pitch email
“Book an Uber after my last meeting today” to:
“CONDITION: after my last meeting today
ACTION: book Uber
“Set a follow-up meeting with Brian at my first availability next week” to:
CONDITION: at my first availability next week
ACTION: set follow up meeting with Brian
“Remind me to bring a towel when I have a Yoga class” to:
CONDITION: when I have a
ACTION: remind me to bring a towel
BOTH: yoga class
Segmenting a natural language query is discussed more with respect
to FIG. 7.

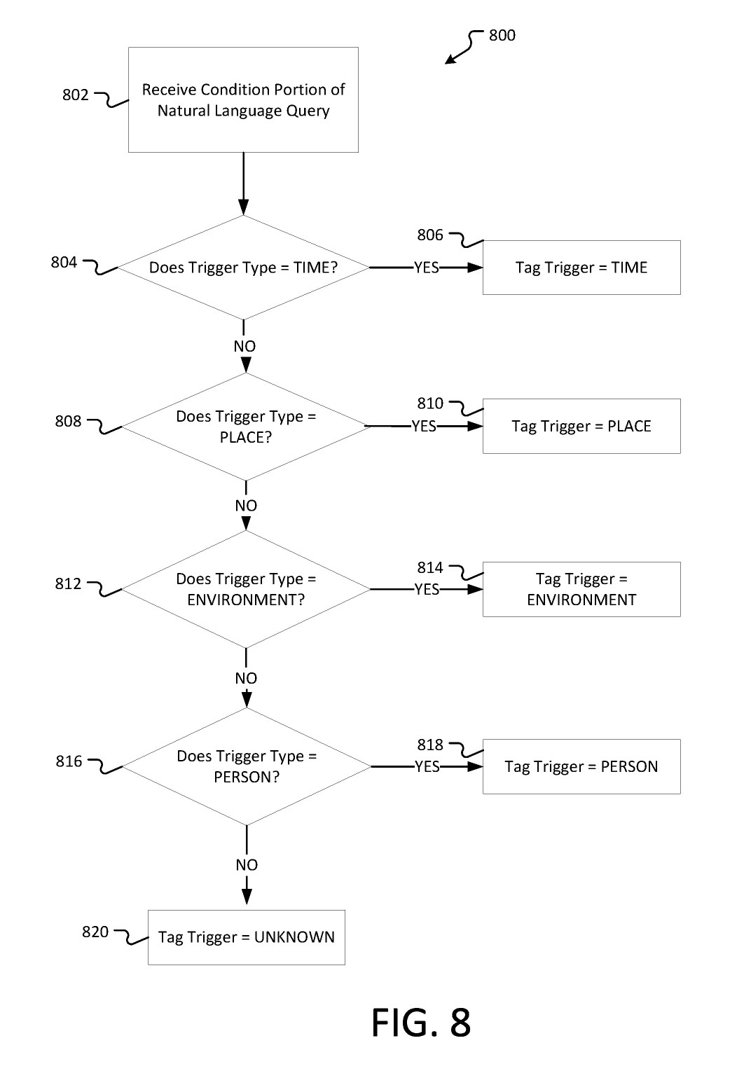

System 300 also includes a conditional classification engine 302. The conditional classification engine classifies the type of condition (also referred to as a “trigger-type”) based on trigger words or trigger phrases. For example, the condition may be time based (e.g., next sundown), location based (e.g., when I get home), schedule based (e.g., in my next meeting with my boss), motion based (e.g., next time I am traveling greater than 60 mph), environment based (e.g., when the forecast for the next day shows rain), or any other type of condition. The conditional classification engine 302 may identify the type of condition in a variety of ways. In the foregoing example, the condition “When I get home” is a location-based condition based on an analysis of the phrase “when I get home”. Discussion of classifying conditions and determining trigger-types is discussed more with reference to FIG. 8.

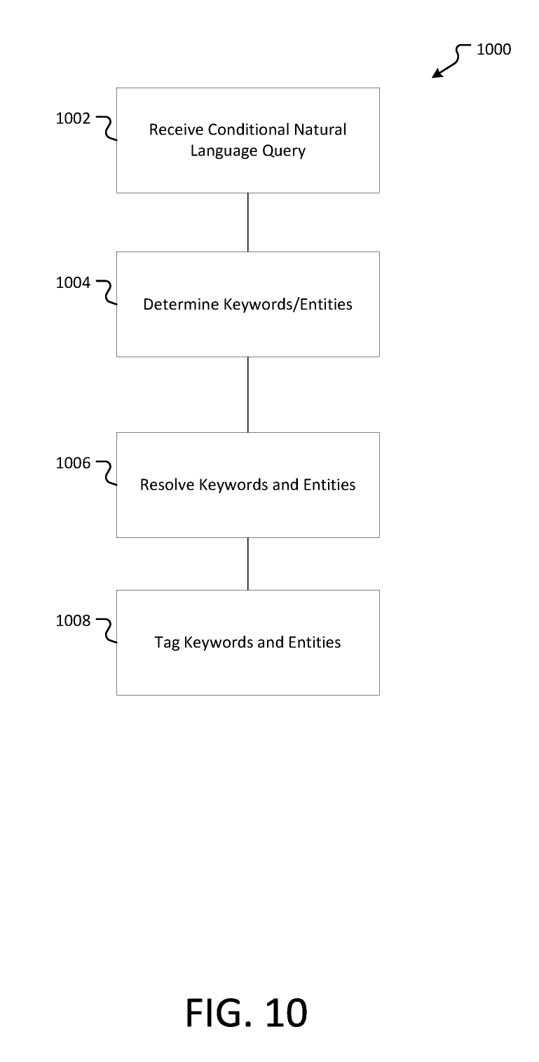

System 300 also includes a condition keyword/entity detection engine 304. The condition keyword/entity detection engine 304 identifies key word, phrases and/or entities in the condition portion of the natural language query by analyzing and tagging the functions of words in the condition portion. For example, the condition portion of a conditional natural language query may be “when I get home?” The conditional keyword/entity detection engine 304 may identify that the word “home” has a particular meaning—it is a location with a known address and coordinates. The tagging of these words may allow other engines, such as conditional semantic frame engine to resolve the semantic meaning of the condition portion of the conditional natural language query. Discussion of noun phrase/entity detection is discussed more with reference to FIG. 10.

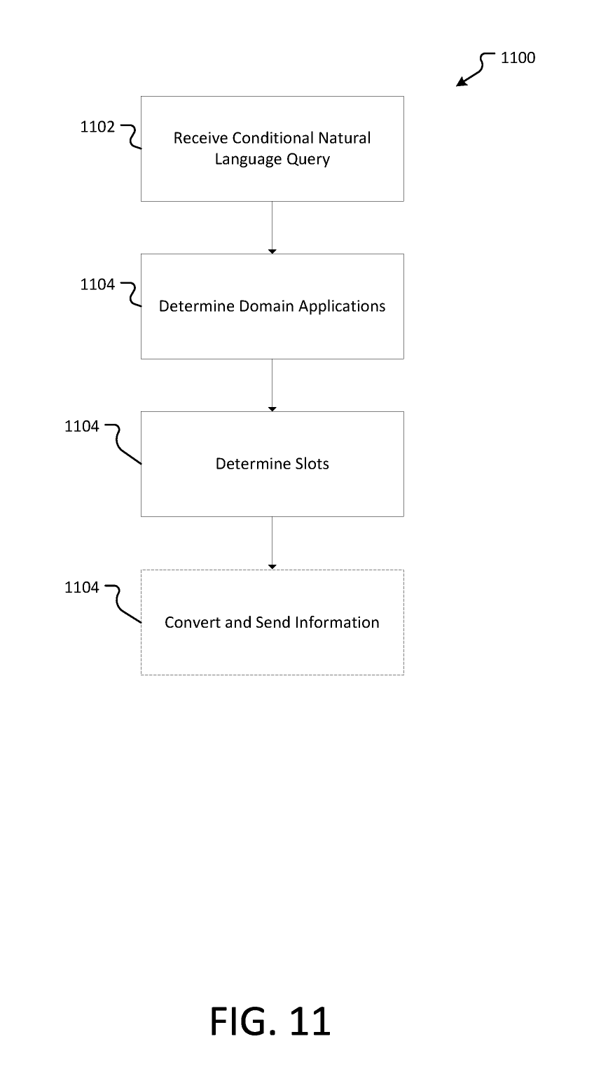

Additionally, system 300 also includes a conditional semantic frame engine 306. The conditional semantic frame engine creates a semantic frame for the condition portion of the query. In particular, the semantic frame engine 306 may combine the information derived from the conditional classification engine 302 and the keyword/entity detection engine 304 to create a semantic frame understandable by other applications. As discussed above, this may include the domain application and slots for such application to use to examine whether the condition has been met. Continuing with the above example, the phrase “when I get home” may be resolved by identifying the domain and any slots that might be helpful to resolve the condition. For example, the conditional statement “when I get home” may be resolved by identifying that the user is attempting to set a location based condition. As such, the domain may be in a location or mapping application. The slots may be the location of the user device and the location of the user's home address. Thus, the phrase “when I get home” may be resolved to the following semantic frame:
DOMAIN=mapping application;
SLOTS=geographic coordinates for “home”; current location
   Discussion of semantic frame identification is discussed more with reference to FIG. 11.

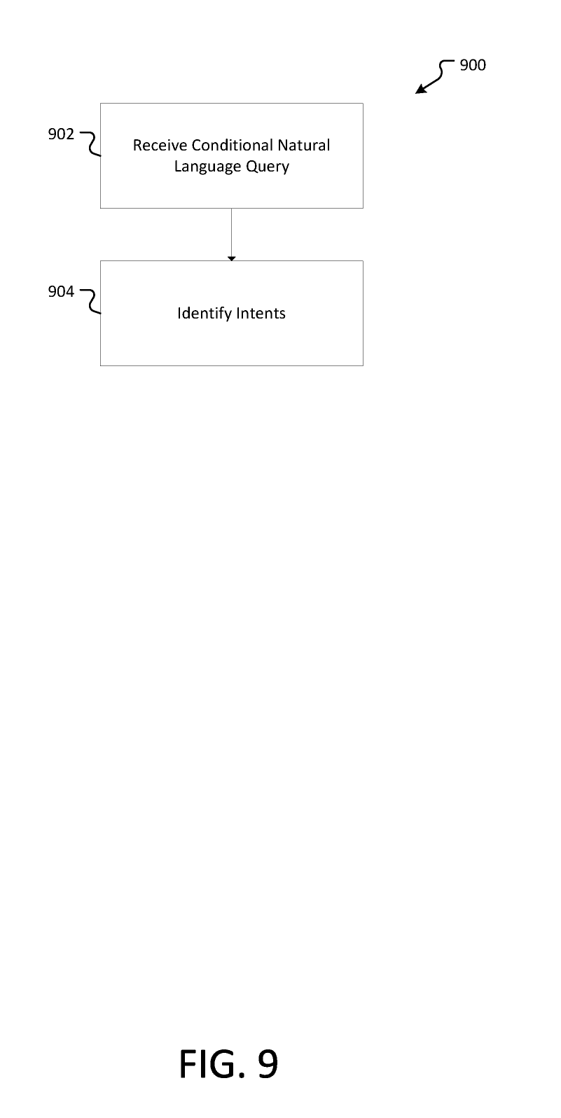

Additionally, system 300 includes action intent identifier engine 308. The action intent identifier engine 308 identifies the intent of the user for the action portion of the conditional natural language query. For example, where the action portion of the conditional natural language query is “text my mom that I got home okay,” the intent of the user may be identified as to send a text. Discussion of determining intents is discussed more with reference to FIG. 9

The system 300 also includes an action keyword/entity detection engine 310, which identifies key noun phrases and entities in the action portion of the natural language query by analyzing and tagging the functions of words in the action portion. The engine 308 looks for relationships between the words in the action portion. For example, the action portion of a conditional natural language query may be “text my mom that I got home okay?” The action keyword/entity detection engine 310 may identify the words “I got home okay” as related words. In aspects, the action keyword/entity detection engine 310 may also tag identified entities and/or keywords. The tagging of these words may allow other engines, such as action semantic frame engine 312 to resolve the semantic meaning of the action portion of the conditional natural language query. Discussion of noun/phrase entity detection continues with reference to FIG. 10.

System 300 also includes an action semantic frame engine 312. The action semantic frame engine 312 determines the semantic frame (e.g., forms a construct that identifies the intents, domains, and slots and the relationship between each for the action portion) for the action portion of the query. For example, the phrase “text my mom that I got home okay” may be resolved to identify a domain, such as a texting application that is capable of resolving the user's intent (which in this example, is to send a text). The action semantic frame engine 312 may then use tagged words identified by the action keyword/entity detection engine 310 to identify the slots for text. For example, in the text domain the slots may include who to send the text to and what text to send. These slots may be filled with “mom” for “who to the send the text to” and “I got home okay” for “what text to send” in the previous example. Thus, the phrase “text my mom that I got home okay” may be resolved to the following semantic frame:
DOMAIN=texting application
INTENT=send text to Mom
SLOTS=mom's text number; “I got home okay”
   Once the intent, domain, and slots are identified, the information may be passed to another application for execution of the action when the condition(s) are satisfied. Discussion of determining semantic structure is discussed more with reference to FIG. 11.

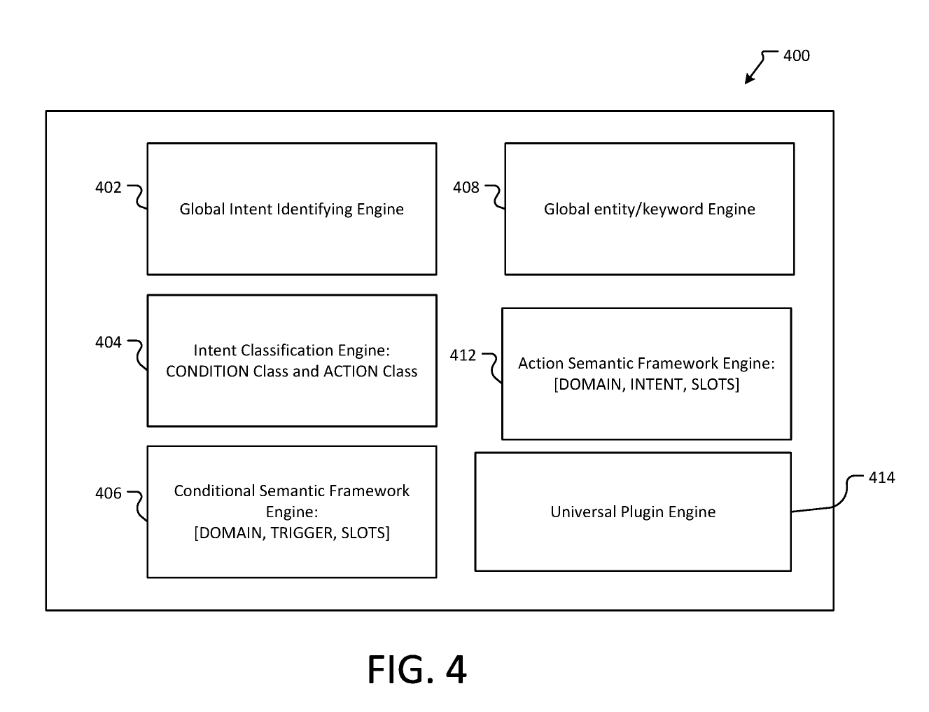

FIG. 4 illustrates an alternate embodiment for resolving conditional natural language user queries. As illustrated system 400 includes a global intent identification engine 402, an intent classification engine 404, a conditional semantic frame engine 406, the global entity/keyword engine 408, an entity/keyword assignment engine 410, and an action semantic frame engine 412. System 400 may be or form a part of conditional query resolution engine 114 and conditional query resolution engine 214 described above with reference to FIGS. 1 and 2. It will be appreciated that while an order of the components in FIG. 4 is presented, a natural language query may be processed by any of the components in any order.

The global intent identification engine 402 receives a conditional natural language query. The global intent engine 402 analyzes the entire query and assigns an intent to one or more portions of the query. For example, a conditional natural language query may include: “this afternoon, if it begins to rain, remind me to buy hard cider and text my children to wear their rain boots.” The global intent identification engine 402 may analyze this conditional natural language query and determine that the intent is to set a reminder and send a text message when two conditions are true: (1) that it is raining and (2) the time is between 12 and 5 pm. Discussion of determining intent is continued more with reference to FIG. 9.

System 400 also includes an intent classification engine 404. Intent classification engine 404 classifies the identified intents into either an action class or a conditional class. To continue the example above,

| | | | |
|---|---|---|---|
| IF | DO | BOTH | NEITHER |

| | | |
|---|---|---|
| Set | | x |
| reminder | | |
| Send a | | x |
| text | | |
| message | | |
| Determine | x | |
| if it is | | |
| raining | | |
| Determine | x | |
| if the time | | |
| is | | |
| between | | |
| 12 and 5 | | |
| pm | | |

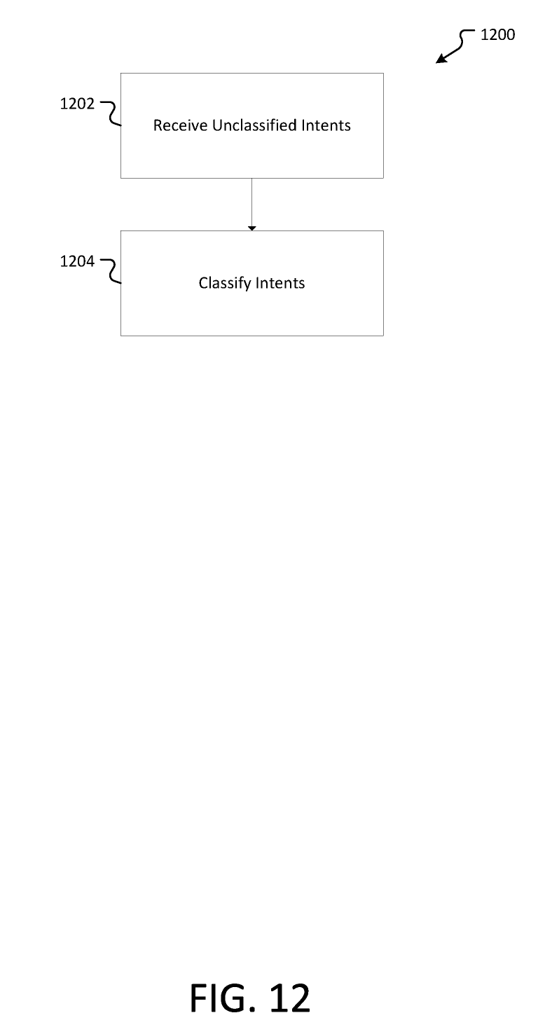

Discussion of intent classification is discussed further with reference to FIG. 12.

System 400 also includes the global entity/keyword engine 408. The global the global entity/keyword engine 408 identifies key noun phrases and entities in the entire natural language query by analyzing and tagging the functions of words. For example, the natural language query may include “hard cider.” The conditional keyword/entity detection engine 304 may identify that the words “hard cider” are related and mean an alcoholic beverage rather than a frozen drink. Discussion of detecting keywords and entities is continued with reference to FIG. 10.

System 400 includes conditional semantic frame engine 406 and action semantic frame engine 412. Conditional semantic frame engine 406 provides a semantic context (e.g., forms a construct that identifies the intents, domains, and slots and the relationship between each identified intent, domain, and slot). The semantic frame engine 406 may then use tagged words identified by the global keyword/entity engine 408 to identify domains, conditions, and slots. Continuing with the above example, a domain may be identified as a weather application, another condition may be identified using a scheduling application, an intent may have been identified that may be fulfilled using a reminder application domain, and another intent may be identified that may be fulfilled using the text domain application. Slots of the reminder application may be filled with the words “buy hard cider” and slots of the text application may be filled with the numbers associated with the user's children and the words “wear rain boots.” Once the intent, domain, and slots are identified, the information may be passed to another application for execution of the action when the condition(s) are satisfied. In sum, the semantic frame for the foregoing example will be:

This afternoon:
Domain: Time
Intent: Determine if current time is in afternoon
Slots: Current time, target time

If it's raining:
Domain: Weather application
Intent: Determine current weather
Slots: Day, location
Domain: Time

Remind me to buy hard cider:
Domain: Reminder application
Intent: Set reminder
Slot: Reminder information

Text my children to wear their rain boots
Domain: Text application
Intent: Send text message
Slots: Text recipient, message

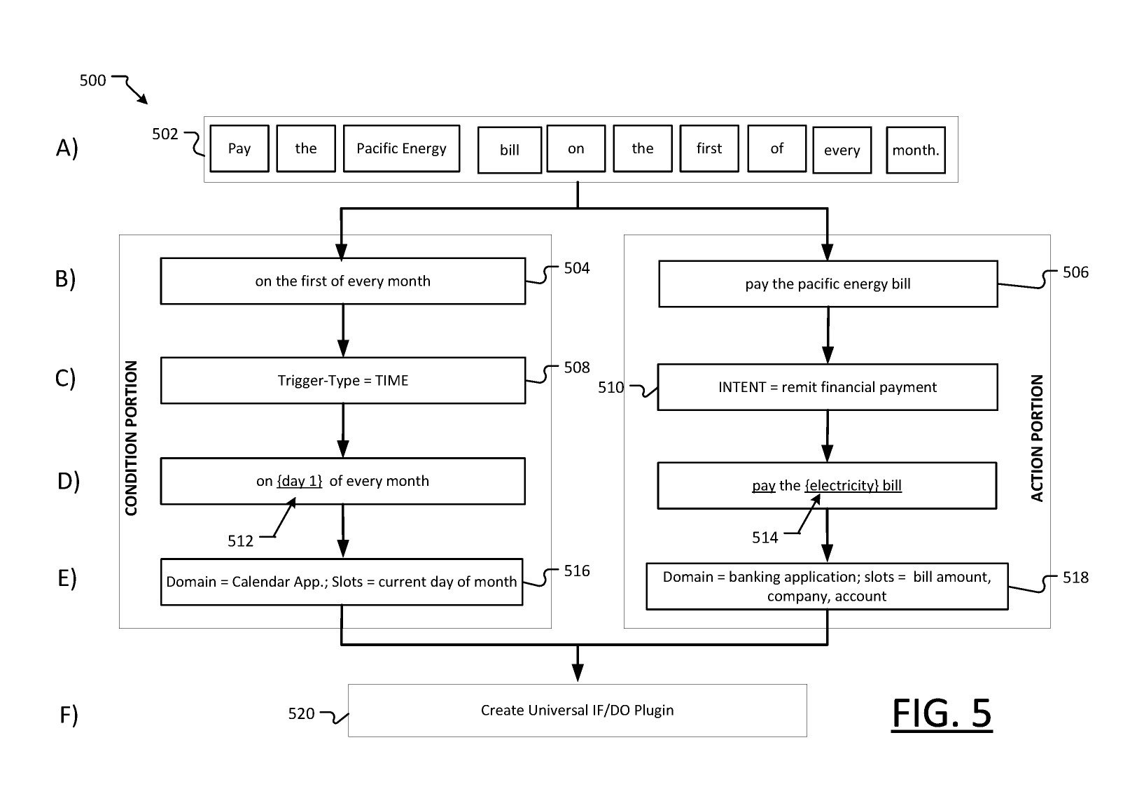

Discussion of determining semantic structure is discussed more with reference to FIG. 11. FIG. 5 is an illustration 500 of the resolution of a conditional natural language query using the system 300 described above. As illustrated, FIG. 5 includes the conditional natural language query 502 “Pay the Pacific Energy bill on the first of every month.” The conditional natural language query 502 may have been received through text or audio input. It will be appreciated that the illustrated conditional natural language query 502 is but one example of a conditional natural language query.

At sequence B, the conditional natural query is split into a condition portion 504 and an action portion 506. As discussed above, this query is divided into its constituent terms and each term is classified into one of the following categories: condition (e.g. “IF”), action (e.g., “DO”), or neither (e.g., not “IF” or “DO”). Query 502 is categorized as follows:

| | IF | DO | BOTH | Neither |
|---|---|---|---|---|
| pay | | X | | |
| the | | X | | |
| pacific | | X | | |
| energy | | X | | |
| bill | | X | | |
| on | X | | | |
| the | X | | | |
| first | X | | | |
| of | X | | | |
| every | X | | | |
| month, | X | | | |
| okay | | | | X |

The foregoing is used to identify the illustrated the condition portion 504 is “on the first of every month” and the action portion 506 is “pay the Pacific Energy bill.” The word “okay” is ignored. The condition portion 504 and the action portion 506 may be determined by the segmentation engine 302 as described above with respect to FIG. 3.

At sequence C, the trigger type 508 for the condition portion is determined and the intent 510 for the action portion is determined. In aspects of the technology, a machine learned model will be trained on a specific number of trigger types. In the event that trigger type 508 cannot be resolved for the condition portion or the intent 510 cannot be resolved for the action portion, the corresponding phrase may be sent back to a user for clarification or may be ignored. In one embodiment, there are five possible identifications of trigger types: 1) TIME; (2) PLACE; (3) PERSON; (4) ENVIRONMENT; and (5) NOT RECOGNIZED (e.g. none of the foregoing). For example, for the condition portion 504, the system recognizes the terms such as “month” as a time based condition or trigger. In other embodiments, a machine learned model is used to identify the trigger type 508. For the action portion 506, the system may recognize the terms: “pay” and “bill” as relating to a financial/banking intent, or a machine learned model may be used to identify the intent 510. The identification of the trigger type 508 and intent 510 may be accomplished using a rule based system or a machine learned model as described below.

At sequence D, each of the condition portion 504 and the action portion 506 are parsed to determine and tag keywords and entities. As illustrated, the phrase “on the first” is identified as keyword 512, and resolved to {day 1}. Further, the words “pacific energy” are identified as a second specific entity 514 and resolved to “electricity.” Further, keywords and entities are tagged (as shown by underlining in FIG. 5), which tags may be used to create the semantic frame for the condition portion 504 and the action portion 506. Here, the keywords 512 “day 1” and are tagged and the entity 514 “electricity” is tagged (shown with underlining). This determination and resolution may occur because a system, such as the systems discussed with reference to FIGS. 3 and 4, may have used a natural language model that has been trained to recognize these keywords and phrases. These determinations and resolutions may be done by the Conditional Keyword/Entity Detection Engine 304 and the Action Keyword/Entity Detection Engine 310 described with reference to FIG. 3 and/or the Entity/Keyword Detection Engine 410 described with reference to FIG. 4.

At sequence E, a semantic frame for each portion is created. As illustrated, a conditional semantic frame 516 includes an identification of a domain application that can be used to identify when the trigger type 508 is satisfied. In this example, the domain application is a calendar application, which may be used to identify when a time condition has been satisfied. Slots may be identified. In this case, the slot to identify when a condition is satisfied is the current day of the month. That is, the calendar application may use the current day of the month to determine whether the condition is satisfied (e.g., is today the first day of the month?).

Further, an action semantic frame 518 is constructed at sequence E. In aspects, a domain application is identified that can satisfy the intent. In the example, this may be a banking application. Slots are identified, which may include the amount to pay, the company to pay, and the account from which to pay. The action semantic frame 518 includes the banking application domain and the slots as bill amount, company, and account number. Each of the conditional semantic frame 516 and the action semantic frame 518 may be passed to another application for further resolution. The semantic frames 516 and 518 may be determined as described with respect to FIGS. 3 and 4.

At sequence F, the semantic frames are packaged into a standardized plug-in 520 that may be understood by multiple applications of the same type, including for example different calendar applications such as Microsoft's Outlook™, Google Calendar™, or Mac Basics: Calendar™, and different banking applications such as Quicken™. The identified domain application is then sent the semantic frame for further processing.

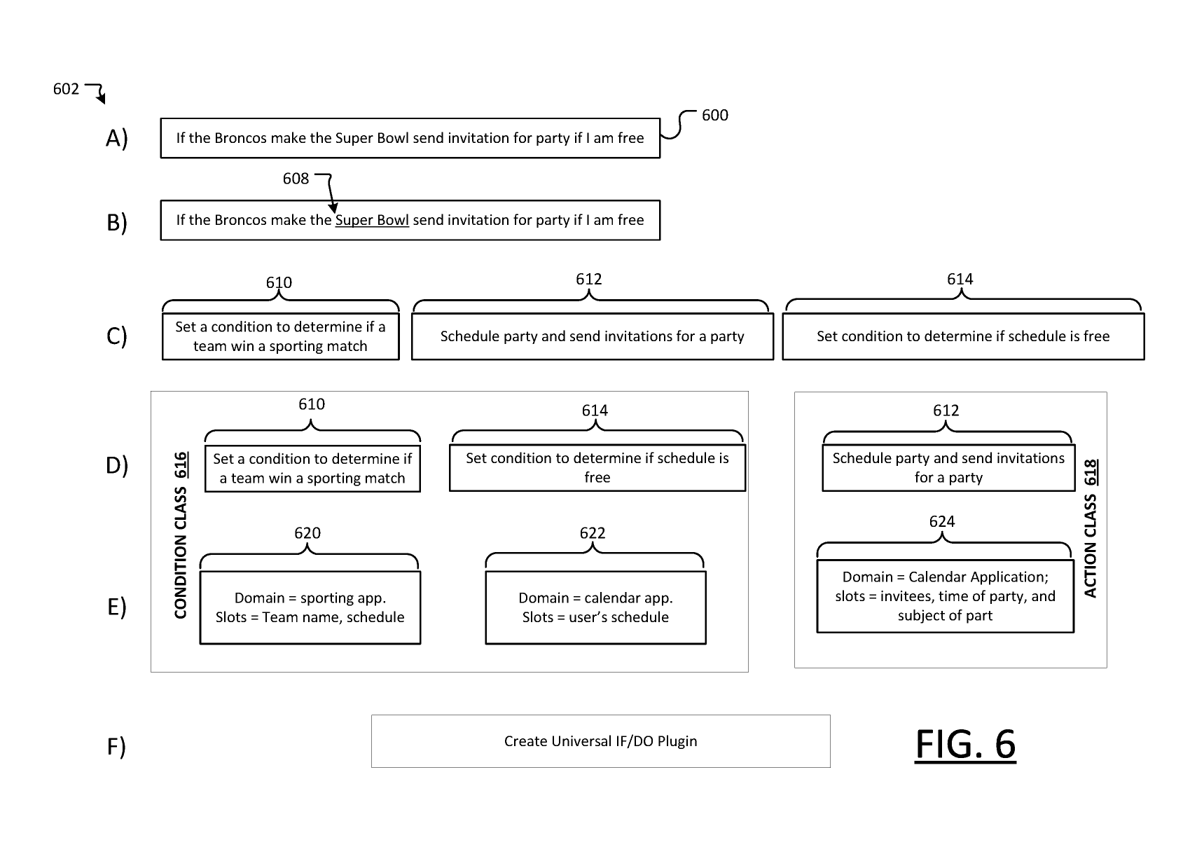

FIG. 6 is an illustration 600 of an another embodiment of the resolution of a conditional natural language query 602 using the system 400 described above.

At sequence A, a conditional natural language query 602 is received. The query 602 may be received by a computing device via audio or text input. Further, the query may have been sent over a network to a conditional query resolution engine for processing. For example, the query “if the Broncos make the Super Bowl send invitation for party if I am free” is received.

At sequence B, the entire query is analyzed to identify keywords, phrases, and entities. As illustrated the words “Super” and “Bowl” are identified as being related and are grouped together in a group 608 and may be tagged. Keywords and entities are tagged. For example, the phrase “super bowl” is tagged as the championship game of the National Football league. Tagging is shown by the underline in the query.

At sequence C, one or more intents of the entire natural language query 602 are identified. As illustrated, three intents are identified. A first intent 610 is to set a condition related to a sports team winning a sporting match, the second intent 612 includes scheduling and sending out invitations for a party, the third intent 614 is to set a condition to determine if the user's schedule is free.

At sequence D, each of the intents is assigned to either a condition class or an action class. This may be accomplished by examining the underlying intent determined at sequence C. As illustrated, the first intent 610 and the third intent 614 are grouped into a condition class 616. The second intent 612 is grouped into the action class 618. This can be accomplished using the same or similar method described below with reference to FIG. 12.

At sequence E, a semantic frame for each intent is determined using similar methods to those described above with reference to 11. As illustrated, the first intent 610 is assigned a first semantic frame 620, where the domain is a sports application and the slots team name and schedule, and the teams playing. The second intent 612 is assigned a second semantic frame 624 in the action class 618. As illustrated, the second semantic frame includes calendar application domain with slots are date, time, place, duration, subject, and invitees for the party. Additionally, the third intent 614 is assigned a third semantic frame 622 in conditional class 616. As illustrated the third semantic frame includes a calendar domain, and the slots are the user's schedule.

At sequence F, the semantic frames are packaged into a plug-in 520 that may be universally understood by any application, including different calendar applications such as Microsoft's Outlook™, Google Calendar™, or Mac Basics: Calendar™, different banking applications such as Quicken™. The identified domain application is then sent the semantic frame for further processing.

FIG. 7 is a method 700 of segmenting a conditional natural language query. Segmenting a conditional natural language component may be performed using the segmentation engine 301 (shown in FIG. 3), for example. Method 700 begins with receive conditional natural language query operation 702. In aspects, a conditional natural language is received via a text, an audio input, a series of gestures, or the like.

Method 700 proceeds to identify portions operation 704. At operation 704, the conditional natural language query is parsed to identify portions of the conditional natural language query. The parsing may be done using a machined learned model. For example, a machine learned model for processing conditional natural language queries may have been trained on a set of conditional natural language queries such that the machined learned model can determine portions of conditional natural language queries. The machine learned model may then be fed the conditional natural language query that was received in operation 702. The machine learned model parses the received natural language query and determines which portions of the received conditional natural language query are related to the condition section, and which portions of the received natural language query are related to the action section. This may be determined once the machine learned model assigns a statistical confidence identifying a portion as either a condition or an action, and the statistical confidence meets or exceeds a predetermined threshold.

Method 700 then proceeds to tag operation 706. In tag operation 706, the portions of the natural language query are tagged as relating to the condition portion (e.g., “IF”, condition portion 504 shown in FIG. 5), the action portion (e.g., “DO”, action portion 506 shown in FIG. 5), both the condition portion and the action portion (e.g., “BOTH”), or neither (e.g., “NEITHER”, unresolved.

Method 700 then proceeds operation 706, where the portions that have been tagged as IF and/or BOTH are passed to a conditional classification engine, such as conditional classification engine 314 for further processing. At operation 708, the portions tagged as DO or BOTH are passed to an action intent identifier engine, such as action intent identifier 308 for further processing. Words that are do not fall into the categories IF, DO, or BOTH, are tagged as NEITHER, and are ignored at operation 712.

then proceeds to segment operation 708. In segment operation 706, the tagged portions are separated. For example, each portion may be stored in a new data location.

FIG. 8 is a method of classifying conditions or identifying a condition's trigger type. The conditional natural language query may include one or more trigger types. The trigger types may include: TIME, LOCATION, ENVIRONMENT; EVENT; PERSON; and CATCHALL. Based on the trigger(s), one or more actions are taken by a computer system (or systems). Classifying conditions may be performed by a conditional classification engine 302 (shown in FIG. 3).

Method 800 begins with receive operation 802. In aspects, a condition portion of the natural language query is received. In aspects, the condition portion that was received may be tagged as a condition portion. In some aspects, the condition portion is received along with the other portions of a conditional natural language query.

Method 800 proceeds to classify trigger operation 804. In parse operation 804, the condition portion is parsed to determine one or more triggers in the condition portion. For example, a machine learned model for processing condition portions may have been trained on a set of condition portions such that the machine learned model recognizes triggers of many condition portions. The machine learned model may then be fed the condition portion of a conditional natural language query that was received in operation 802. The machine learned model parses the condition portion and determines what triggers are present (e.g., location based, time based, date based, etc.). This may be determined once the machine learned model assigns a statistical confidence the assignment of a trigger to the word or words that relate to a particular condition, and that the statistical confidence meets or exceeds a predetermined threshold.

Method 800 then proceeds to trigger type-time determination 804. In determination 804, it is determined whether the trigger is time based. This may be done using a machine learned model. If the trigger type is time, then the method 800 proceeds to tag operation 806 where the trigger-type is tagged as time.

Method 800 then proceeds to trigger type-place determination 808. In determination 808, it is determined whether the trigger is location based. This may be done using a machine learned model. If the trigger type is location based, then the method 800 proceeds to tag operation 810 where the trigger-type is tagged as place.

Method 800 then proceeds to trigger type-environment determination 812. In determination 812, it is determined whether the trigger is environment based. This may be done using a machine learned model. If the trigger type is environment based, then the method 800 proceeds to tag operation 814 where the trigger-type is tagged as environment.

Method 800 then proceeds to trigger type-environment determination 812. In determination 812, it is determined whether the trigger is environment based. This may be done using a machine learned model. If the trigger type is environment based, then the method 800 proceeds to tag operation 814 where the trigger-type is tagged as environment.

Method 800 then proceeds to trigger type-person determination 816. In determination 816, it is determined whether the trigger is person based. This may be done using a machine learned model. If the trigger type is person based, then the method 800 proceeds to tag operation 816 where the trigger-type is tagged as person.

Method 800 then proceeds to trigger type-UNKNOWN operation 820. If a trigger is unidentified, the trigger may be tagged as unknown. An unknown tag may result in the a system requiring more information from a user, for example.

FIG. 9 is a method 900 of determining one or more intents (such as intents 610, 612, and 614 shown in FIG. 6) of a conditional natural language query. Method 900 may be performed by the Action Intent Identifier Engine 308 (shown in FIG. 3) or the Global Intent Identifying Engine 402 (shown in FIG. 4). Method 900 begins with receive operation 902. In aspects, a conditional natural language query (or portion thereof) is received at operation 902. The conditional natural language query may include one or more tags that identify an action portion, a condition portion, a trigger-type, or other tag.

Method 900 proceeds to identify intent of the conditional natural language query operation 904. In operation 904, the conditional natural language is parsed to determine one or more intents of the conditional natural language query. For example, a machine learned model for determining intents may have been trained on a set of conditional natural language queries such that the machine learned model recognizes the likely intents of a user based on the words used in the natural language query. The machine learned model may then be fed the conditional natural language query that was received in operation 902. The machine learned model parses the natural language query and determines what the likely intents of the user is. This may be determined once the machine learned model assigns a statistical confidence to potential intents associated with one or more words in the conditional natural language query, and that statistical confidence meets or exceeds a predetermined threshold. The identified intents may then be passed to an application, module, or engine for further processing. For example, if method 900 is performed by the Action Intent Identifier Engine 308, then the determined intents will be sent to the Action Semantic Framework Engine 312 (shown in FIG. 3). If, on the other hand, method 900 is performed by the Global Intent Identifying Engine 402, the determined intents will be sent on to the Global entity/keyword Engine 408 and/or the Intent Classification Engine 404 (shown in FIG. 4).

FIG. 10 is a method 1000 of determining one or more keywords/entities in a natural language query. Method 1000 may be performed by the Conditional Keyword/Entity Detection Engine 304 (shown in FIG. 3), the Action Keyword/Entity Detection Engine 310 (shown in FIG. 3), Global entity/keyword Engine 408 (shown in FIG. 4). Method 1000 begins with receive operation 1002. In aspects, a conditional natural language query (or portion thereof) is received at operation 1002. The conditional natural language query may include a tag that identifies an action portion, a condition portion, or a trigger-type or other tag.

Method 1000 proceeds to determine keywords/entities of the conditional natural language query operation 1004. In operation 1004, the conditional natural language is parsed to determine one or more keywords and/or entities of the conditional natural language query. For example, a machine learned model for identifying keywords/entities may have been trained on a set of conditional natural language queries such that the machine learned model recognizes keywords and entities of conditional natural language queries. The machine learned model may then be fed the conditional natural language query that was received in operation 1002. The machine learned model parses the natural language query and determines what keywords/entities are present. This may be determined once the machine learned model assigns a statistical confidence to the word or words that represent likely keywords/entities, and that statistical confidence meets or exceeds a predetermined threshold. The identified keywords/entities may then be passed to an application, module, or engine for further processing.

The method 1000 then proceeds to resolve keywords and entity operation 1006. In resolve keywords or entities, the semantic meaning of the keyword or entity is resolved. For example, if the entity is “Super Bowl” the words may be resolved to “NFL championship game.”

Method 1000 then proceeds to tag keywords and entities operation 1008. In operation 1008, the resolved keywords and entities are tagged with the resolved semantic meanings.

The tagged keywords and entities may then be passed to an application, module, or engine for further processing. For example, if method 1000 is performed by the Action Intent Identifier Engine 308, then the determined intents will be sent to the Action Semantic Framework Engine 312 (shown in FIG. 3). If, on the other hand, method 900 is performed by the Global Intent Identifying Engine 402, the determined intents will be sent on to the Global entity/keyword Engine 408 and/or the Intent Classification Engine 404 (shown in FIG. 4).

FIG. 11 is a method 1100 of determining semantic structure of a natural language query also known as building a semantic frame. Method 1100 may be performed by the Condition Semantic Frame Engine 306 (shown in FIG. 3), the Action Semantic Frame Engine 312 (shown in FIG. 3), Condition Semantic Frame Engine 406 (shown in FIG. 4), and/or the Action Semantic Frame Engine 412 (shown in FIG. 4). Method 1100 begins with receive operation 1102. In aspects, a conditional natural language query (or portion thereof) is received at operation 1102. The conditional natural language query may include a tag that identifies an action portion, a condition portion, or a trigger-type or other tag. Intents may have been identified or trigger-types.

Method 1100 proceeds to determine domain applications. At operation 1104, a domain application corresponding to the identified intent and/or trigger type is identified. For example, a trigger type of location may have been identified. In such an instance, a mapping application may be used to determine whether the trigger has been satisfied. For an action portion, the intent may have been identified as a intent to make a phone call. In such an instance, a domain application of a phone-call application may be identified. Identification of domain applications based on intents and trigger types may be performed using a machine learned model. Alternatively, it may be rule based.

Next, the slots of the identified domain application are identified at operation 1106. For example, the slots for a phone call application may include the number to dial. In aspects, the natural language query received at 1102 may include information to fill those slots. For example, if the conditional natural language query includes the phrase “call my mom when I get home” the location of the user may be a slot for the mapping application. Additionally, the contact information for the user's mom may be used to fill in the number for a phone call application. Filling slots may be accomplished using a machine learned model.

The semantic frame (such as semantic frames 516 and 518 shown in FIG. 5 and semantic frames 620, 622, and 624 shown in FIG. 6) is built at operation 1108. The resulting semantic frame, including identified slots for a domain application may be optionally converted into commands for the application at operation 1110. The commands may then be sent to the identified domain application for execution of the action when the condition is met. Additionally and optionally, the semantic frame may be sent to the standard plugin (such as plugin engine 314 shown in FIG. 3 and plugin engine 414 shown in FIG. 4) to be converted into a format that is understandable by any application. As a specific example, the slots may be converted into the native format understandable by the identified domain application. For example, if the conditional natural language query where “if it begins to rain, set my alarm to 6:30 am,” the information may have initially been received as an alphanumeric string. The words “6:30 am” may be converted to 06:30 and stored as an integer to allow an alarm application to interpret the input. In other examples, the semantic frame may be a standardized format, which format may then may be exposed to other applications.

FIG. 12 is a method 1200 of classifying intents. Method 1200 begins with receive operation 1102. This may be performed by intent classification engine 404 (shown in FIG. 4). In aspects, the intents of a conditional natural language query (or portion thereof) is received at operation 1102.

One or more intents of a conditional natural language query are classified as a conditional intent or an action intent. In an embodiment, the default is an action intent where everything that is not a condition intent will be considered an action intent. In aspects, a machine learned model for classifying intents is used. The machine learned model may have been trained on a set of conditional natural language queries such that the machine learned model recognizes intents as either a conditional intent, an action intent, or an unknown intent. The machine learned model may then be fed the conditional natural language query that was received in operation 1202. The machine learned model parses the conditional natural language query and determines and classifies intents. Intents may be classified once the machine learned model assigns a statistical confidence to the classification on an intent, and that statistical confidence meets or exceeds a predetermined threshold. The classified intent may then be passed to an application, module, or engine for further processing.

At decision 1204, it is determined whether the intent (such as intents 610, 612, and 614 shown in FIG. 6) is a condition. If the answer is NO, method 1200 proceed to operation 1206 where the intent is classified in the condition class (such as condition class 616 shown in FIG. 6) Method proceeds to operation 1212 where the condition portion is sent to the Condition Semantic Frame Engine 406. Method 1200 then proceeds to decision 1214 where it is determined whether there is another intent in the query. If the answer is yes, method 1200 proceeds back to operation 1202 where the method begins again. If the answer is NO, the process ends at step 1216.

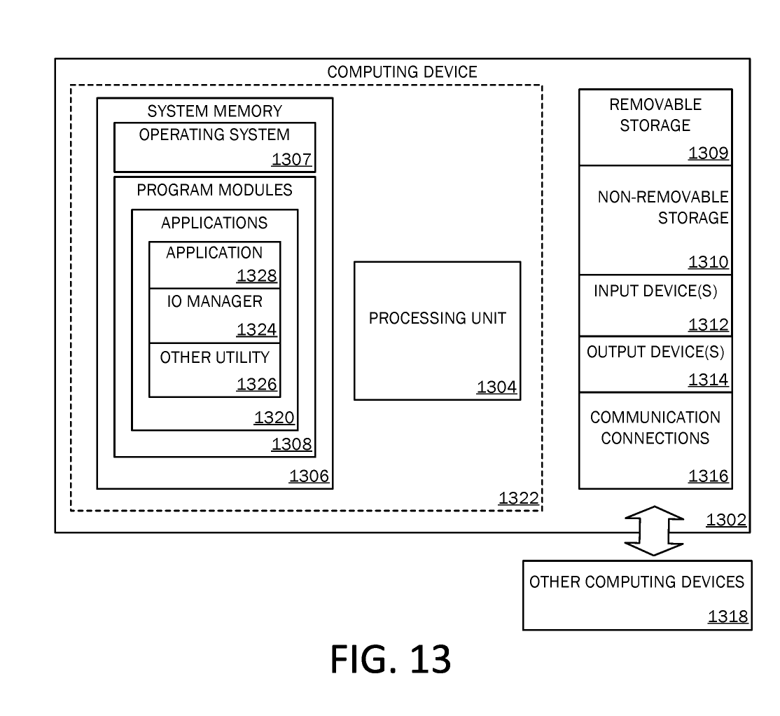

If the answer is NO at decision 1204, method 1200 proceeds to operation 1206 where the intent is classified in the Action Class (such as action class 618 shown in FIG. 6). At operation 1208, the action intent is sent to the Action Semantic Frame Engine 412. The method then proceeds to decision 1214 where it is determined whether there is another intent in the query. If the answer is yes, method 1200 proceeds back to operation 1202 where the method begins again. FIGS. 13-15 and the associated descriptions provide a discussion of a variety of operating environments in which examples of the invention may be practiced. However, the devices and systems illustrated and discussed with respect to FIGS. 13-15are for purposes of example and illustration and are not limiting of a vast number of computing device configurations that may be utilized for practicing examples of the invention, described herein.

FIG. 13 is a block diagram illustrating physical components of a computing device 1302, for example a component of a system with which examples of the present disclosure may be practiced. The computing device components described below may be suitable for the computing devices described above. In a basic configuration, the computing device 1302 may include at least one processing unit 1304 and a system memory 1306. Depending on the configuration and type of computing device, the system memory 806 may comprise, but is not limited to, volatile storage (e.g., random access memory), non-volatile storage (e.g., read-only memory), flash memory, or any combination of such memories. The system memory 1306 may include an operating system 1307 and one or more program modules 1308 suitable for running software applications 1320 such as application 1328, 10 manager 1324, and other utility 1326. As examples, system memory 1306 may store instructions for execution. Other examples of system memory 1306 may have components such as a knowledge resource or learned program pool, as examples. The operating system 1307, for example, may be suitable for controlling the operation of the computing device 1302. Furthermore, examples of the invention may be practiced in conjunction with a graphics library, other operating systems, or any other application program and is not limited to any particular application or system. This basic configuration is illustrated in FIG. 12 by those components within a dashed line 1322. The computing device 1302 may have additional features or functionality. For example, the computing device 1302 may also include additional data storage devices (removable and/or non-removable) such as, for example, magnetic disks, optical disks, or tape. Such additional storage is illustrated in FIG. 13 by a removable storage device 1309 and a non-removable storage device 1310.

As stated above, a number of program engines and data files may be stored in the system memory 1306. While executing on the processing unit 1304, the program modules 1308 (e.g., application 1328, Input/Output (I/O) manager 1324, and other utility 1326) may perform processes including, but not limited to, one or more of the stages of the operational method 500, 600, and 700 illustrated in FIGS. 5, 6, and 7. Other program engines that may be used in accordance with examples of the present invention may include electronic mail and contacts applications, word processing applications, spreadsheet applications, database applications, slide presentation applications, input recognition applications, drawing or computer-aided application programs, etc.

Furthermore, examples of the invention may be practiced in an electrical circuit comprising discrete electronic elements, packaged or integrated electronic chips containing logic gates, a circuit utilizing a microprocessor, or on a single chip containing electronic elements or microprocessors. For example, examples of the invention may be practiced via a system-on-a-chip (SOC) where each or many of the components illustrated in FIG. 13 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality described herein may be operated via application-specific logic integrated with other components of the computing device 1302 on the single integrated circuit (chip). Examples of the present disclosure may also be practiced using other technologies capable of performing logical operations such as, for example, AND, OR, and NOT, including but not limited to mechanical, optical, fluidic, and quantum technologies. In addition, examples of the invention may be practiced within a general purpose computer or in any other circuits or systems.

The computing device 1302 may also have one or more input device(s) 1312 such as a keyboard, a mouse, a pen, a sound input device, a device for voice input/recognition, a touch input device, etc. The output device(s) 1314 such as a display, speakers, a printer, etc. may also be included. The aforementioned devices are examples and others may be used. The computing device 1302 may include one or more communication connections 1316 allowing communications with other computing devices 1318. Examples of suitable communication connections 1316 include, but are not limited to, radio frequency (RF) transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program engines. The system memory 1306, the removable storage device 1309, and the non-removable storage device 1310 are all computer storage media examples (i.e., memory storage.) Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 1302. Any such computer storage media may be part of the computing device 1302. Computer storage media does not include a carrier wave or other propagated or modulated data signal.

Communication media may be embodied by computer readable instructions, data structures, program engines, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, RF, infrared, and other wireless media.

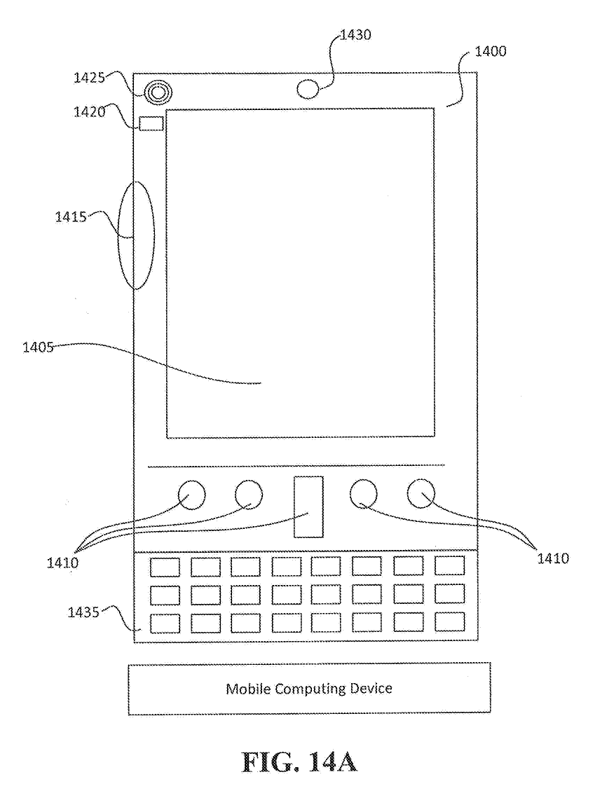

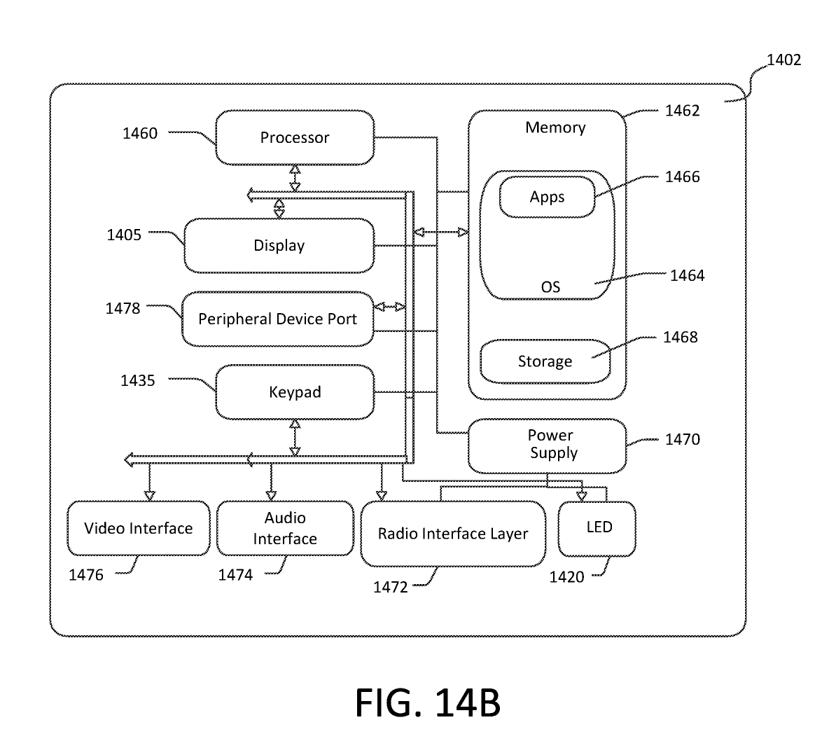

FIGS. 14A and 14B illustrate a mobile computing device 1400, for example, a mobile telephone, a smart phone, a personal data assistant, a tablet personal computer, a laptop computer, and the like, with which examples of the invention may be practiced. For example, mobile computing device 1400 may be implemented as system 100, components of systems 100 may be configured to execute processing methods as described in FIGS. 5, 6, and/or 7, among other examples. With reference to FIG. 14A, one example of a mobile computing device 1400 for implementing the examples is illustrated. In a basic configuration, the mobile computing device 1400 is a handheld computer having both input elements and output elements. The mobile computing device 1400 typically includes a display 1405 and one or more input buttons 1410 that allow the user to enter information into the mobile computing device 1400. The display 1405 of the mobile computing device 1400 may also function as an input device (e.g., a touch screen display). If included, an optional side input element 1415 allows further user input. The side input element 1415 may be a rotary switch, a button, or any other type of manual input element. In alternative examples, mobile computing device 1400 may incorporate more or less input elements. For example, the display 1405 may not be a touch screen in some examples. In yet another alternative example, the mobile computing device 1400 is a portable phone system, such as a cellular phone. The mobile computing device 1400 may also include an optional keypad 1435. Optional keypad 1435 may be a physical keypad or a “soft” keypad generated on the touch screen display. In various examples, the output elements include the display 1405 for showing a graphical user interface (GUI), a visual indicator 1420 (e.g., a light emitting diode), and/or an audio transducer 1425 (e.g., a speaker). In some examples, the mobile computing device 1400 incorporates a vibration transducer for providing the user with tactile feedback. In yet another example, the mobile computing device 1400 incorporates input and/or output ports, such as an audio input (e.g., a microphone jack), an audio output (e.g., a headphone jack), and a video output (e.g., a HDMI port) for sending signals to or receiving signals from an external device.

FIG. 14B is a block diagram illustrating the architecture of one example of a mobile computing device. That is, the mobile computing device 1400 can incorporate a system (i.e., an architecture) 1402 to implement some examples. In examples, the system 1402 is implemented as a “smart phone” capable of running one or more applications (e.g., browser, e-mail, input processing, calendaring, contact managers, messaging clients, games, and media clients/players). In some examples, the system 1402 is integrated as a computing device, such as an integrated personal digital assistant (PDA) and wireless phone.

One or more application programs 1466 may be loaded into the memory 1462 and run on or in association with the operating system 1464. Examples of the application programs include phone dialer programs, e-mail programs, personal information management (PIM) programs, word processing programs, spreadsheet programs, Internet browser programs, messaging programs, and so forth. The system 1402 also includes a non-volatile storage area 1468 within the memory 1462. The non-volatile storage area 968 may be used to store persistent information that should not be lost if the system 1402 is powered down. The application programs 1466 may use and store information in the non-volatile storage area 1468, such as e-mail or other messages used by an e-mail application, and the like. A synchronization application (not shown) also resides on the system 1402 and is programmed to interact with a corresponding synchronization application resident on a host computer to keep the information stored in the non-volatile storage area 1468 synchronized with corresponding information stored at the host computer. As should be appreciated, other applications may be loaded into the memory 1462 and run on the mobile computing device 1400, including application 1328, IO manager 1324, and other utility 1326 described herein.

The system 1402 has a power supply 1470, which may be implemented as one or more batteries. The power supply 1470 might further include an external power source, such as an AC adapter or a powered docking cradle that supplements or recharges the batteries.

The system 1402 may include peripheral device port 1478 that performs the function of facilitating connectivity between system 1402 and one or more peripheral devices. Transmissions to and from the peripheral device port 1478 are conducted under control of the operating system 1464. In other words, communications received by the peripheral device port 1478 may be disseminated to the application programs 1466 via the operating system 1464, and vice versa.

The system 1402 may also include a radio 1472 that performs the function of transmitting and receiving radio frequency communications. The radio 1472 facilitates wireless connectivity between the system 1402 and the “outside world,” via a communications carrier or service provider. Transmissions to and from the radio 1472 are conducted under control of the operating system 1464. In other words, communications received by the radio 1472 may be disseminated to the application programs 1466 via the operating system 1464, and vice versa.

The visual indicator 1420 may be used to provide visual notifications, and/or an audio interface 1474 may be used for producing audible notifications via the audio transducer 1425. In the illustrated example, the visual indicator 1420 is a light emitting diode (LED) and the audio transducer 1425 is a speaker. These devices may be directly coupled to the power supply 1470 so that when activated, they remain on for a duration dictated by the notification mechanism even though the processor 1460 and other components might shut down for conserving battery power. The LED may be programmed to remain on indefinitely until the user takes action to indicate the powered-on status of the device. The audio interface 1474 is used to provide audible signals to and receive audible signals from the user. For example, in addition to being coupled to the audio transducer 1425, the audio interface 1474 may also be coupled to a microphone to receive audible input, such as to facilitate a telephone conversation. In accordance with examples of the present invention, the microphone may also serve as an audio sensor to facilitate control of notifications, as will be described below. The system 1402 may further include a video interface 1476 that enables an operation of an on-board camera 1430 to record still images, video stream, and the like.

A mobile computing device 1400 implementing the system 1402 may have additional features or functionality. For example, the mobile computing device 1400 may also include additional data storage devices (removable and/or non-removable) such as, magnetic disks, optical disks, or tape. Such additional storage is illustrated in FIG. 14B by the non-volatile storage area 1468.

Data/information generated or captured by the mobile computing device 1400 and stored via the system 1402 may be stored locally on the mobile computing device 1400, as described above, or the data may be stored on any number of storage media that may be accessed by the device via the radio 1472 or via a wired connection between the mobile computing device 1400 and a separate computing device associated with the mobile computing device 1400, for example, a server computer in a distributed computing network, such as the Internet. As should be appreciated such data/information may be accessed via the mobile computing device 1400 via the radio 1472 or via a distributed computing network. Similarly, such data/information may be readily transferred between computing devices for storage and use according to well-known data/information transfer and storage means, including electronic mail and collaborative data/information sharing systems.

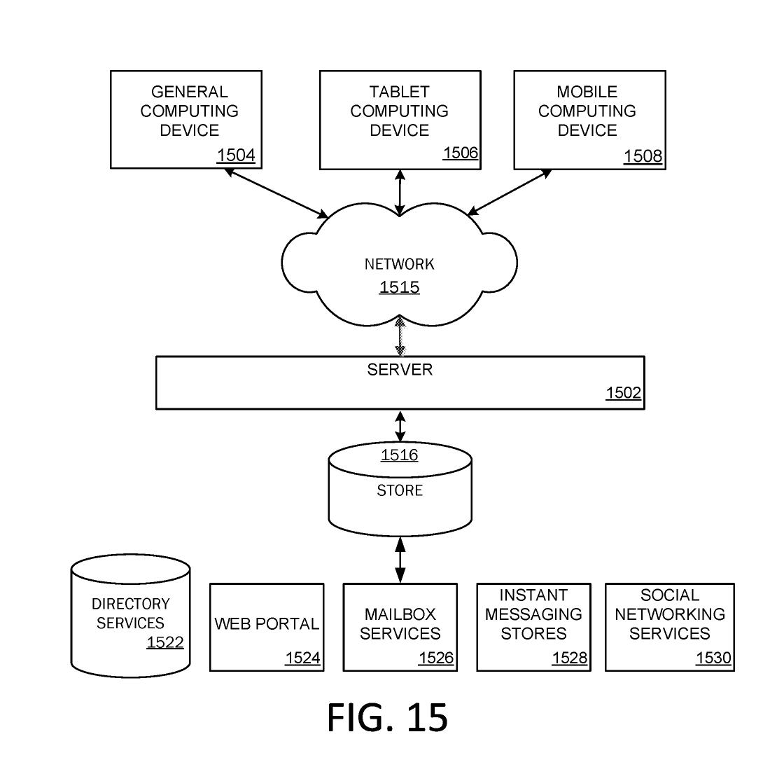

FIG. 15 illustrates one aspect of the architecture of a system for processing data received at a computing system from a remote source, such as a computing device 1504, tablet 1506, or mobile device 1508, as described above. A query transformation may be running at server device 1502 and may be stored in different communication channels or other storage types, such as data store 1516. In aspects, the general computing device 1504 is executing a digital assistant that is part of the file history system described herein. Further, in this aspect, the tablet 1506 is thin digital assistant that is part of the file history system described herein. Additionally, in this aspect, the mobile computing device 1508 is executing a spreadsheet application that is part of the file history system described herein. Systems and methods for simplifying natural language queries are described in detail above and illustrated in FIGS. 1-12. In addition, various queries may be received using a directory service 1522, a web portal 1524, a mailbox service 1526, an instant messaging store 1528, or a social networking site 1530.

Aspects of the technology include a system. The system may include at least one processor operatively coupled to at least one computer storage memory device. The device may have instructions that when executed perform a method. In aspects, the method includes receiving a natural language query. The method may also include a transformation sequence to apply to the natural language query. The transformation sequence may comprise two or more of: key concept detection, dependency filtering, stop structure removal, stop word removal, and noun/phrase entity detection. In aspects, the method also includes applying a transformation sequence to the natural language query to generate a transformed natural query. The method may additionally include sending the transformed natural language query.

Additionally, the transformation sequence may include an ordered sequence. The order sequence may be one of applying a key concept detection, applying dependency filtering, applying stop structure removal, applying stop word removal, and applying noun/phrase entity detection. Further, the transformed natural language query may be sent to an Internet search engine application.

In aspects, the method may further include, prior to determining the transformation sequence, identifying an origination of the natural language query. The determining the transformation sequence may be based on the origination of the natural language query. In aspects, the origination of the natural language query may be an Internet search engine application stored on a computing device.

In aspects, the key concept detection may apply a weight to at least a portion of the natural language query, and the weight may be used by the Internet search engine to rank results. Further, the key concept detection may identify a portion of the natural language query, and the application of the stop word removal may not affect the portion of the natural language query. These above referenced functionality may be employed as a computer method, a system, and/or a computer readable storage device.

Reference has been made throughout this specification to “one example” or “an example,” meaning that a particular described feature, structure, or characteristic is included in at least one example. Thus, usage of such phrases may refer to more than just one example. Furthermore, the described features, structures, or characteristics may be combined in any suitable manner in one or more examples.

One skilled in the relevant art may recognize, however, that the examples may be practiced without one or more of the specific details, or with other methods, resources, materials, etc. In other instances, well known structures, resources, or operations have not been shown or described in detail merely to observe obscuring aspects of the examples.

While sample examples and applications have been illustrated and described, it is to be understood that the examples are not limited to the precise configuration and resources described above. Various modifications, changes, and variations apparent to those skilled in the art may be made in the arrangement, operation, and details of the methods and systems disclosed herein without departing from the scope of the claimed examples.

What is claimed:

1. A system comprising at least one processor in electronic communication with a memory, the memory storing computer-readable instructions that when executed by the processor cause the system to:
receive a conditional query;
segment the conditional query into a condition portion and an action portion;
determine a trigger type for the condition portion;
tag a keyword in the condition portion;
build a condition semantic frame for the condition portion based on the trigger type and the tagged keyword in the condition portion;
determine an intent of the action portion;
tag a keyword in the action portion; and
build an action semantic frame for the action portion based on the intent and the tagged keyword in the action portion.

2. The system of claim 1, further comprising computer-readable instructions stored in the memory that when executed by the processor cause the system to:
segment the conditional query into a plurality of individual words;
tag each of the individual words with one of a condition tag, an action tag, or a both tag;
assign each of individual words that are tagged with the condition tag or the both tag to the condition portion; and
assign each of individual words that are tagged with the action tag or the both tag to the action portion.

3. The system of claim 1, wherein the trigger type is one of time, place, environment, person, and not recognized.

4. The system of claim 3, further comprising computer-readable instructions stored in the memory that when executed by the processor cause the system to:
identify the trigger type is unknown when it is determined that the trigger type is not one of time, place, environment, and person.

5. The system of claim 1, further comprising computer-readable instructions stored in the memory that when executed by the processor cause the system to:
determine that the condition portion comprises two conditions, wherein each condition has a different trigger type.

6. The system of claim 1, wherein the intent of the action portion comprises at least one of: sending a text, sending an invitation, making a phone call, scheduling an appointment, changing a setting, and changing an appointment.

7. A computer implemented method, the method comprising:
receiving a conditional query;
segmenting the conditional query into a condition portion and an action portion;
determining a trigger type for the condition portion;
tagging a keyword in the condition portion;
determining a semantic meaning for the condition portion based on the trigger type and the tagged keyword in the condition portion;
determining an intent of the action portion;
tagging a keyword in the action portion; and
determining a semantic meaning for the action portion based on the intent and the tagged keyword in the action portion.

8. The computer-implemented method of claim 7, wherein the step of segmenting the conditional query into a condition portion and an action portion further comprises:
segmenting the conditional query into a plurality of individual words;
tagging each of the individual words with one of a condition tag, an action tag, or both tag;
grouping each of individual words that are tagged with the condition tag or the both tag into the condition portion; and
grouping each of individual words that are tagged with the action tag or the both tag into the action portion.

9. The computer-implemented method of claim 7, wherein the trigger type is one of time, place, environment, person, and not recognized.

10. The computer-implemented method of claim 7, further comprising:
building a condition semantic frame from the semantic meaning for the condition portion; and
building an action semantic frame from the semantic meaning for the action portion.

11. The computer-implemented method of claim 10, further comprising:
building a standardized plugin with the condition semantic frame and the action semantic frame.

12. The method of claim 7, further comprising:
exposing the standardized plugin to a plurality of applications.

13. The computer-implemented method of claim 7, wherein the intent of the action portion comprises at least one of: sending a text, sending an invitation, making a phone call, scheduling an appointment, changing a setting, and changing an appointment.

14. A system comprising at least one processor in electronic communication with a memory, the memory storing computer-readable instructions that when executed by the processor cause the system to:
receive a conditional query;
tag a plurality of keywords in the conditional query, wherein the plurality of keywords comprises a first tagged keyword and a second tagged keyword;
identify a plurality of intents for the conditional query, wherein the plurality of intents comprises a first intent and a second intent, and wherein the first intent is identified based on the first tagged keyword and the second intent is identified based on the second tagged keyword
assign the first intent to a condition class;
build a condition semantic frame based on at least the first keyword, wherein the condition semantic frame identifies a domain application and a slot;
assign the second intent to an action class; and
build an action semantic frame based on at least the second keyword, wherein the action semantic frame identifies a domain application and a slot.

15. The system of claim 14, further comprising computer-readable instructions stored in the memory that when executed by the processor cause the system to:
tag third keyword in the conditional query;
identify a third intent based on the third keyword;
assign the third intent to the condition class; and
build a second condition semantic frame based on at least the third keyword, wherein the second condition semantic frame identifies a domain application and a slot.

16. The system of claim 14, wherein the condition semantic frame includes a plurality of slots.

17. The system of claim 14, wherein the action semantic frame includes a intent.

18. The system of claim 14, wherein at least one of the plurality of tagged keywords is an entity.

19. The system of claim 14, further comprising computer-readable instructions stored in the memory that when executed by the processor cause the system to:
resolve a sematic meaning of a keyword in the conditional query; and
tag the resolved keyword.

20. The system of claim 14, further comprising computer-readable instructions stored in the memory that when executed by the processor cause the system to:
build a standardized plugin with the condition semantic frame and the action semantic frame.
